(19) United States
(12) Patent Application Publication
(10) Pub. No.: US 2014/0374672 A1
(43) Pub. Date: Dec. 25, 2014

(54) CONDUCTIVE METAL INKS WITH POLYVINYLBUTYRAL BINDER

(71) Applicant: XEROX CORPORATION, Norwalk, CT (US)

(72) Inventors: Naveen CHOPRA, Oakville (CA); Gabriel IFTIME, Mississauga (CA); James D. MAYO, Mississauga (CA); Michael D'AMATO, Thornhill (CA); Sandra J. Gardner, Oakville (CA); Cuong VONG, Hamilton (CA); Ping LIU, Mississauga (CA); Yiliang WU, Oakville (CA)

(21) Appl. No.: 13/925,506

(22) Filed: Jun. 24, 2013

(51) Int. Cl. C09D 11/00

(52) U.S. Cl. CPC C09D 11/52
USPC 252/514

(57) ABSTRACT

A conductive ink includes a conductive material, a thermoplastic polyvinylbutyral terpolymer binder and a glycol ether solvent. The conductive material may be a conductive material is a conductive particulate having an average size of from about 0.5 to about 10 microns and as aspect ratio of at least about 3 to 1, such as a silver flake.

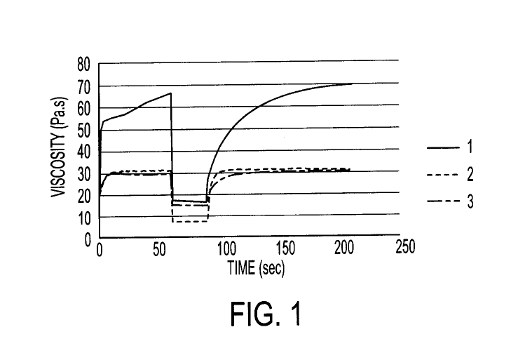

### BACKGROUND

The current total market value for silver inks is estimated to be approximately $8 billion annually. A current main use for silver inks is for printing conductive lines and interconnects between electric parts in devices. Devices utilizing silver inks include, for example, home appliances, such as in control panels of the home appliances, for example for flat membrane sensors and switches, consumer electronics, computers, cell phones and solar panels.

Fabrication of electronic elements using liquid deposition techniques is of profound interest as such techniques provide potentially low-cost alternatives in applications such as thin film transistors (TFTs), light-emitting diodes (LEDs), RFID tags, photovoltaics, and the like. However the deposition and/or patterning of functional electrodes, pixel pads, and conductive traces, lines and tracks which meet the conductivity, processing, and cost requirements for practical applications have been a great challenge.

While the market for silver paste is well established in the above-mentioned applications, there are great opportunities if problems with silver ink were solved, such as low conductivity or high sheet resistance when compared with pure metals, and cost, in view of the rising cost of silver.

Thus, a performance concern with most commercially available conductive inks, for example conductive inks comprised of a conductive flake such as silver, binder and solvent, is that the conductivity is too low when compared with pure metal. For commercial silver ink pastes from suppliers such as DuPont or Henkel, a sheet resistivity of the inks typically ranges from 12 to 25 mΩ/sq./mil.

Conductive inks with a reduced sheet resistance would be a great enabler for the use of the inks in a wide range of products requiring exceptional conductive interconnections between electronic components, such as sensors, photovoltaic panels, flat OLED lighting and so on. Furthermore, conductive inks with increased conductivity may allow for the printing of thinner lines, therefore reducing materials costs.

There thus remains a need for conductive inks exhibiting improved properties, including, for example, improved viscosity and/or conductivity properties enabling reduced usage of ink and enabling finer printed features to be formed on a substrate.

### SUMMARY

The above and other issues are addressed by the present application, wherein in embodiments, the application relates to a conductive ink comprised of a conductive material, a thermoplastic polyvinylbutyral terpolymer binder and a glycol ether solvent.

Also described herein is a conductive ink comprised of a conductive material, a thermoplastic polyvinylbutyral terpolymer binder and a glycol ether solvent, wherein the ink has a sheet resistivity of 12.5 mΩ/sq./mil or less.

Further described is a conductive ink comprised of a silver flake having an average size of about 2 to about 5 microns, a polyvinylbutyral terpolymer binder having the formula

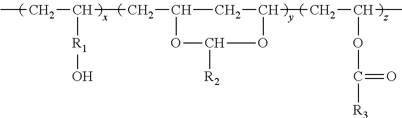

wherein R₁ is a chemical bond or a divalent hydrocarbon linkage having from about 1 to about 20 carbons; R₂ and R₃ are independently an alkyl group, an aromatic group or a substituted aromatic group having from about 1 to about 20 carbon atoms; x, y and z independently represent the proportion of the corresponding repeat units respectively expressed as a weight percent, wherein each repeat unit is randomly distributed along polymer chain, a sum of x, y and z is about 100 weight percent, and x is from about 3 weight percent to about 50 weight percent, y is from about 50 weight percent to about 95 weight percent, and z is from about 0.1 weight percent to about 15 weight percent, and a glycol ether solvent.

### BRIEF DESCRIPTION OF THE DRAWING

The FIGURE is a graph summarizing ink shear of the conductive ink of the application as compared to two commercially available conductive inks.

### EMBODIMENTS

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

“Optional” or “optionally” refer, for example, to instances in which subsequently described circumstances may or may not occur, and include instances in which the circumstance occurs and instances in which the circumstance does not occur.

The phrases “one or more” and “at least one” refer, for example, to instances in which one of the subsequently described circumstances occurs, and to instances in which more than one of the subsequently described circumstances occurs.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

Described herein is a conductive ink composition comprised of a conductive material, a polyvinylbutyral terpolymer binder and a glycol ether solvent.

As the conductive material, any material in particulate form may be used, wherein the particle has an average size of from, for example, 0.5 to 15 microns, such as 1 to 10 microns or 2 to 10 microns. While the particle may be of any shape, desirably the conductive material is of a two dimensional shape, such as a flake shape, including rods, cones and plates, or needle shape, and having, for example, an aspect ratio of at least about 3 to 1, such as at least about 5 to 1.

The conductive material may be comprised of any conductive metal or metal alloy material. Suitable conductive materials may include, for example, metals such as at least one selected from gold, silver, nickel, indium, zinc, titanium, copper, chromium, tantalum, tungsten, platinum, palladium, iron, cobalt, and alloys thereof. A combination comprising at least one of the foregoing can be used. The conductive material may also be a base material coated or plated with one or more of the foregoing metals or alloys, for example silver plated copper flakes. For cost, availability and performance reasons, desirable conductive materials comprise silver or silver plated materials.

Silver flakes having an average flake size of from, for example, 1 to 10 microns, such as 2 to 10 microns, may be used.

The conductive material may be present in the conductive paste in an amount of from, for example, about 50 to about 95 weight percent of the ink, such as about 60 to about 90 weight percent or about 70 to about 90 weight percent.

The ink also includes at least one polyvinylbutyral (PVB) terpolymer thermoplastic binder. The PVB terpolymer binder is desirably a material that possesses a reasonably high viscosity to allow the ink to retain the pattern following printing with a Tg that allows the thermoplastic material to be melted or softened, and shear thinned, at reasonable temperatures (lower Tg being desirable for this aspect) yet also allows for the printed ink to be robust (requiring a higher Tg). The polyvinylbutyral terpolymer may have a weight average molecular weight (Mw) of about 10,000 to about 600,000 Da, such as from about 40,000 to about 300,000 Da or from about 40,000 to about 250,000 Da. The Tg of the PVB terpolymer binder is from, for example, about 60° C. to about 100° C., such as from about 60° C. to about 85° C. or from about 62° C. to about 78° C.

The polyvinylbutyral (PVB) terpolymer has the following formula:

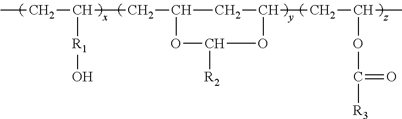

wherein R₁ is a chemical bond, such as a covalent chemical bond, or a divalent hydrocarbon linkage having from about 1 to about 20 carbons, from about 1 to about 15 carbon atoms, from about 4 to about 12 carbon atoms, from about 1 to about 10 carbon atoms, from about 1 to about 8 carbon atoms or from about 1 to about 4 carbon atoms; R₂ and R₃ are independently an alkyl group, such as a methyl, ethyl, propyl, butyl, pentyl, hexyl and heptyl groups, an aromatic group or a substituted aromatic group having from about 1 to about 20 carbon atoms, from about 1 to about 15 carbon atoms, from about 4 to about 12 carbon atoms, from about 1 to about 10 carbon atoms, from about 1 to about 8 carbon atoms or from about 1 to about 4 carbon atoms; x, y and z represent the proportion of the corresponding repeat units respectively expressed as a weight percent, wherein each repeat unit is randomly distributed along polymer chain, and the sum of x, y and z is about 100 weight percent; x is independently from about 3 weight percent to about 50 weight percent, from about 5 weight percent to about 40 weight percent, from about 5 weight percent to about 25 weight percent and from about 5 weight percent to about 15 weight percent; y is independently from about 50 weight percent to about 95 weight percent, from about 60 weight percent to about 95 weight percent, from about 75 weight percent to about 95 weight percent and from about 80 weight percent to about 85 weight percent; z is independently from about 0.1 weight percent to about 15 weight percent, from about 0.1 weight percent to about 10 weight percent, from about 0.1 weight percent to about 5 weight percent and from about 0.1 weight percent to about 3 weight percent.

The polyvinylbutyral terpolymer may be derived from a vinyl butyral, a vinyl alcohol and a vinyl acetate. A representative composition of the polyvinylbutyral terpolymer constitutes, on a weight basis, about 10 to about 25% hydroxyl groups, calculated as polyvinyl alcohol, about 0.1 to about 2.5% acetate groups calculated as polyvinyl acetate, with the balance being vinyl butyral groups. The Mw and Tg of the terpolymer may be adjusted through adjustment of the x, y and z values.

In the PVB terpolymer, R₁ is desirably a bond and x represents the amount of vinyl alcohol units in the terpolymer, R₂ is desirably a 3 carbon alkyl group, and y represents the amount of vinyl butyral units in the terpolymer, and R₃ is a 1 carbon atom alkyl group and z represents the amount of vinyl acetate units in the copolymer. The PVB terpolymer is a random terpolymer.

The properties of the PVB terpolymer may be adjusted by adjusting the content of the different units making up the terpolymer. For example, by including a greater amount of vinyl acetate units and a lesser amount of vinyl butyral units (less y and more z) can yield a more hydrophobic polymer with higher heat distortion temperature, making it tougher and better adhesive. Also, including lower amounts of vinyl alcohol (hydroxyl) units may broaden the solubility properties.

Examples of polyvinylbutyral terpolymers include, for example, polymers manufactured under the trade name MOWITAL (Kuraray America), S-LEC (Sekisui Chemical Company), BUTVAR (Solutia), and PIOLOFORM (Wacker Chemical Company). The PVB terpolymer may be prepared as discussed in U.S. Patent Application Publication No. 2012/0043512, incorporated herein by reference in its entirety.

In addition to the PVB terpolymer binder, it may be possible to include an additional thermoplastic binder. The at least one additional thermoplastic binder may include, for example, polyesters such as terephthalates, terpenes, styrene block copolymers such as styrene-butadiene-styrene copolymer, styrene-isoprene-styrene copolymer, styrene-ethylene/butylene-styrene copolymer, and styrene-ethylene/propylene copolymer, ethylene-vinyl acetate copolymers, ethylene-vinyl acetate-maleic anhydride terpolymers, ethylene butyl acrylate copolymer, ethylene-acrylic acid copolymer, polymethylmethacrylate, polyethylmethacrylate, and other poly(alkyl)methacrylates, polyolefins, polybutene, polyamides, and the like and mixtures thereof.

The binder of the conductive ink may be present in an amount of less than about 10 weight percent of the ink, such as for example from about 0.1 to about 10 weight percent, or from about 0.5 to about 5 weight percent, of the ink.

The binder may be made to have a different Mw and Tg in order to assist in imparting a different viscosity to the ink. Different liquid deposition techniques, for example such as screen printing, offset printing, gravure/flexographic printing and the like, require the use of inks having different viscosity requirements, as discussed above. An ink (including the conductive material therein) including the PVB terpolymer binder herein may have a viscosity in the range of from, for example, about 10,000 to about 70,000 cps. The viscosity may be measured by a variety of methods, but herein is reported as measured with an Ares G2 (TA Instruments). In addition, use of more binder in the ink, and/or less solvent, may act to increase the viscosity of the ink.

The ink also includes at least one solvent. For the PVB binder discussed above, the solvent is a glycol ether solvent. The glycol ether solvent may be a single solvent or a mixture of solvents that dissolve the thermoplastic PVB binder and that can evaporate following printing while being dried under mild drying conditions such as, for example, about 50° C. to about 250° C. Example glycol ether solvents include, for example, ethylene glycol di-C1-C6-alkyl ethers, propylene glycol di-C1-C6-alkyl ethers, diethylene glycol di-C1-C6-alkyl ethers, such as butyl carbitol (diethylene glycol monobutyl ether), dipropylene glycol di-C1-C6-alkyl ethers, or any combination thereof.

The solvent may be used in an amount of from about 5 to 50 weight percent of the ink, such as from about 5 to about 35 weight percent or from about 5 to about 25 weight percent. The amount of solvent or solvents can be adjusted to optimize printing with the ink for the particular printing method, apparatus speed, and the like.

The conductive inks may contain optional additives such as, for example, a plasticizer, a lubricant, a dispersant, a leveling agent, a defoaming agent, an antistatic agent, an antioxidant and a chelating agent as necessary or desired.

The inks of the present application desirably exhibit a rheology in which the viscosity is about 40 Pa·s or more, such as 50-75 Pa·s or more, at a shear of 1 s⁻¹, and in which the viscosity can be reduced to about 25 Pa·s or less when the shear is 50 s⁻¹. This enables the ink to be suitable for application by way of printing methods such as screen printing and the like. The ink may be shear thinned for screen printing application, but thereafter rapidly gains viscosity upon removal of shearing to form a robust printed pattern on the substrate. An example rheology profile of the inks of this application is shown in the FIGURE, discussed further below.

The conductive inks may be made by any suitable method. One example method is to first dissolve the binder(s) in the solvent(s) of the ink, which may be done with the accompanying use of heat and/or stirring. The conductive material may then be added, desirably at a gradual rate of addition to avoid lumping. Heat and/or stirring may again be applied during the addition of the conductive material.

The conductive inks are used to form conductive features on a substrate by printing. The printing may be carried out by depositing the ink on a substrate using any suitable printing technique. The printing of the ink on the substrate can occur either on a substrate or on a substrate already containing layered material, for example, a semiconductor layer and/or an insulating layer.

Printing herein refers to, for example, deposition of the ink composition on the substrate. Printing can also include any coating technique capable of forming the ink into a desired pattern on the substrate. Examples of suitable techniques include, for example, spin coating, blade coating, rod coating, dip coating, lithography or offset printing, gravure, flexography, screen printing, stencil printing, stamping (such as microcontact printing), and the like.

The substrate upon which the conductive ink is deposited may be any suitable substrate, including, for example, silicon, glass plate, plastic film, sheet, fabric, or paper. For structurally flexible devices, plastic substrates, such as for example polyester, polycarbonate, polyimide sheets and the like may be used.

Following printing, the patterned deposited ink is subjected to a curing step. The curing step is a step in which substantially all of the solvent of the ink is removed and the ink is firmly adhered to the substrate. Curing herein does not require a crosslinking or other transformation of the binder, although if a crosslinkable binder is used in the ink it may be crosslinked during the curing step if desired. The curing step is done by subjecting the deposited patterned ink to a temperature of, for example, about 50° C. to about 250° C., such as from about 80° C. to about 220° C. or from about 100° C. to about 210° C. When the curing step is completed, the solvent is essentially evaporated. By removal of substantially all of the solvent is meant that >90% of the solvent is removed from the system. The ink film that remains is essentially only conductive material and binder. The print is not damaged by touching, or in other words is free of tack. The ink film should not offset or transfer onto a different substrate by touching when maintained at a temperature below the Tg of the binder. The length of time for curing may vary, as understood by practitioners in the art, based upon the amount of solvent in the ink, the viscosity of the ink, the method used to form the printed pattern, the temperature used for curing, and the like. For screen printing, the curing may take from, for example, about 5 to about 120 minutes. For offset printing, the curing may take from, for example, 20 seconds to 2 minutes. For gravure and flexographic printing, the curing may take from, for example, 20 seconds to 2 minutes. Longer or shorter times may be used, as necessary.

The heating for curing can be performed in air, in an inert atmosphere, for example, under nitrogen or argon, or in a reducing atmosphere, for example, under nitrogen containing from 1 to about 20 percent by volume hydrogen. The heating can also be performed under normal atmospheric pressure or at a reduced pressure of, for example, from about 1000 mbars to about 0.01 mbars.

As used herein, “heating” encompasses any technique(s) that can impart sufficient energy to the patterned ink to cure the ink. Examples of heating techniques may include thermal heating, infra-red (“IR”) radiation, a laser beam, flash light, microwave radiation, or UV radiation, or a combination thereof.

Following curing, the patterned ink may be subjected to an optional fusing step, for example as described in U.S. application Ser. No. ______ (entitled “Method Of Improving Sheet Resistivity Of Printed Conductive Inks” to Iftime et al., filed on even date herewith), incorporated herein by reference in its entirety. In the fusing step, the cured patterned ink is subjected to a temperature of 20° C. to 130° C. above the Tg of the binder(s) of the ink, such as 20° C. to 100° C. or 30° C. to 80° C. above the Tg of the binder(s). The fusing temperature is achieved via heating such as discussed above. The ink, fusing device and process are such that the conductive paste does not offset (transfer onto the fusing apparatus such as a fuser roll).

In addition to the temperature, the optional fusing also subjects the cured patterned ink to pressure. The pressure may be from about 50 psi to about 1500 psi, such as about 50 psi to about 1200 psi or from about 100 psi to about 1000 psi. The temperature and pressure is desirably applied by feeding the substrate having the cured patterned ink through one or more sets of fuser rolls maintained at the necessary or desired temperature and nip pressure conditions. The feed rate through the one or more sets of fuser rolls is, for example, about 1 m/min to about 100 m/min, such as about 5 in/min to about 75 m/min or from about 5 m/min to about 60 m/min.

As the fuser rolls, any fuser roll materials may be used. For example, the top roll may be a very hard material such as steel, optionally coated with a release agent to assist in avoiding offset, and the bottom roll may be a softer roll, for example a roll coated with a rubber and the like.

In embodiments, the one of the pair of fuser rolls that contacts the printed ink may be made to include a removable release layer on a surface of the roll, such as an oil or wax, to assist in preventing offset of the printed pattern. Suitable oils are chosen from silicon oils and functionalized silicone oils. Specific examples of suitable silicone oils include, for example, polydimethylsiloxane (PDMS). Suitable functionalized oils are chosen from, for example, amino-functionalized PDMS oils and mercapto-functionalized PDMS oils.

Also, the one of the pair of fuser rolls that contacts the printed film may be made to have a surface, for example as a layer or coating, comprised of a material with good release properties. Suitable surfaces may be made of polymers such as polytetrafluoroethylene (PTFE), perfluoroalkoxy polymer resin (PFA), poly(tetrafluoroethylene-co-perfluoropropyl vinyl ether), fluorinated ethylenepropylene copolymer (FEP), copolymers of tetrafluoroethylene and hexafluoropropylene, copolymers of hexafluoropropylene and vinylidene fluoride, terpolymers of tetrafluoroethylene, vinylidene fluoride, and hexafluoropropylene, and tetrapolymers of tetrafluoroethylene, vinylidene fluoride, and hexafluoropropylene, and combinations thereof.

The process of forming the patterned ink on a substrate, curing the patterned ink and optional fusing may be done in an inline continuous manner, or it may be done in discontinuous steps. When the ink is deposited by way of screen printing, the process is typically too time consuming to be done in an inline continuous manner. In screen printing and other discontinuous processes, the patterned ink on the substrate may be stored for some time between the curing and an optional fusing steps. Processes utilizing deposition methods such as offset printing and gravure/flexographic printing are conducive to use with an inline continuous process.

In the inline continuous process, the substrate material, which may be stored in roll or stacked form for easy continuous feeding through the continuous process, is first fed to the printing apparatus where the ink is printed in the predetermined desired pattern onto the substrate. The printed substrate is then continuously progressed from the printing apparatus to a curing station where heat to effect curing is applied. The item is then continuously fed on through to the optional fusing system where pressure and heat may be applied to fuse the ink. The end product may then be collected following exit from the fusing system, and subjected to further processing if needed or desired. For example, the end product may be collected on a take up roll, if appropriate, may be cut and collected, and the like. The feed rate of the materials through the process may be set to the needed speed for printing and curing, and may be the same feed rate as discussed above for the fusing feed rate.

While the curing and fusing steps are separately described, these steps may be performed simultaneously, for example both being done in conjunction with the fusing step. In other words, the heat applied during the fusing step may also act to cure the printed ink, thereby resulting in process efficiencies. In such embodiments, the curing apparatus is within the fusing apparatus such that the apparatus should be considered one and the same.

The resulting elements may be used as electrodes, conductive pads, interconnect, conductive lines, conductive tracks, and the like in electronic devices such as thin film transistors, organic light emitting diodes, RFID (radio frequency identification) tags, photovoltaic, displays, printed antenna and other electronic devices which require conductive elements or components.

The embodiments disclosed herein will now be described in detail with respect to specific exemplary embodiments thereof, it being understood that these examples are intended to be illustrative only and the embodiments disclosed herein is not intended to be limited to the materials, conditions, or process parameters recited herein. All percentages and parts are by weight unless otherwise indicated.

### Example 1

In this example, a sample ink was prepared using 2 to 5 micron silver flakes, PVB binder and glycol ether solvent. The sample ink had the following composition.

TABLE 1

Sample Ink

| | Wt % | m (g) |
|---|---|---|
| Silver flakes (MR-10F (Inframat)) | 75.00 | 650.25 |
| Polyvinylbutyral (Butvar B-98) | 3.75 | 32.51 |
| Butyl carbitol solvent | 21.25 | 184.24 |
| TOTAL | 100.00 | 867.00 |

Note:
B-98 has a Mw of 40,000-70,000 and a Tg of 72-78° C.

The ink was prepared as follows: to a 250 mL beaker equipped with a stainless steel anchor mixing blade was added a 15 wt % solution of binder in butyl carbitol (amounts as specified in Table 1 for each ink). The mixture was heated to 55° C. with a hotplate and stirred at 500 RPM. Next, the silver flakes were added gradually to the mixture in stages to avoid lumping. The mixture was blended for 1 hour, then passed 3 times through a 3-roll-mill (Erweka model AR 400). The finished ink was isolated and transferred to an amber glass jar.

The sample ink, as well as two commercially available conductive inks (DuPont 5025 and Henkel Electrodag 725A) were evaluated for rheological properties in a shear test. In the test, rheology was measured on an Ares G2 instrument (TA Instruments) under the following ink shear protocol, designed to simulate the screen printing process (flooding of screen, squeegee through screen, and recovery on printed substrate): 60 sec at 1 s⁻¹, then 30 sec at 50 s⁻, then 120 sec at 1 s⁻¹. The rheology (viscosity vs. time) is shown in the FIGURE for each of the sample, ink (1 in the FIGURE), DuPont 5025 (2 in the FIGURE) and Henkel Electrodag 725A (3 in the FIGURE). The sample ink shows a superior viscosity profile, attributable to the PVB terpolymer binder and glycol ether solvent of the sample ink. These materials in combination contribute to the high shear thinning index, which is the ratio of viscosity at low shear rates vs. the viscosity at high shear rates

The sample ink and two commercial inks were coated at room temperature using a drawdown square at 1 and 2 mil wet thicknesses using a Gardco automated drawdown apparatus onto 2 mil Mylar films. The films were thermally cured at 120° C. for 30 minutes in a convection oven.

To measure conductivity of the deposited ink, a 2-point probe measurement was performed as follows: lines of about 100 mm length and about 2 mm width were cut into the film to test. Resistance was measured with a multimeter. Thickness of the line coating was measured in several places on the line and an average thickness was calculated. The sheet resistance is given by the following formula:

$$Sheet resistance [ \frac{\frac{Ω}{square}}{mil} ] = \frac{Resistance [ Ω ] * Thickness [ mils ]}{squares number [ dimensionless ]}$$

$$where \text{:}$$

$$squares number = \frac{Lenght [ mm ]}{Width [ mm ]}$$

The sheet resistivity is specific to the ink. The lower the sheet resistance value, the better the conductivity. The goal is to minimize sheet resistance.

The conductivity of each sample was measured, and the value is reported in Table 2.

TABLE 2

| | | | | | | | Avg Sheet |
|---|---|---|---|---|---|---|---|
| | L | W | Thickness | Thickness | | Sheet Resistance | Resistance |
| Sample | (mm) | (mm) | (microns) | (mils) | Squares | (mΩ/square/mil) | (mΩ/square/mil) |
| Sample | 100 | 2.0 | 6.1 | 0.24 | 50 | 13.7 | 12.4 |
| Ink | 100 | 2.0 | 6.2 | 0.25 | 50 | 11.9 | |
| | 100 | 2.0 | 5.8 | 0.23 | 50 | 11.6 | |
| DuPont | | | | | | | 16.3 |
| 5025 | | | | | | | |
| Henkel | | | | | | | 14.9 |
| Electrodag | | | | | | | |
| 725A | | | | | | | |

The foregoing results demonstrate that with the inks of the present application, improved conductivity/sheet resistivity is achieved along with a superior viscosity profile. The inks herein desirably exhibit a sheet resistivity of 12.5 mΩ/sq./mil or less.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A conductive ink comprised of a conductive material, a thermoplastic polyvinylbutyral terpolymer binder and a glycol ether solvent.

2. The conductive ink of claim 1, wherein the conductive material is a conductive particulate having an average size of from about 0.5 to about 10 microns and as aspect ratio of at least about 3 to 1.

3. The conductive ink of claim 2, wherein the conductive material is silver flake having an average size of about 2 to about 10 microns.

4. The conductive ink of claim 1, wherein the conductive material comprises an amount of from about 50 to about 95 weight percent of the ink.

5. The conductive ink of claim 2, wherein the polyvinylbutyral terpolymer has the formula 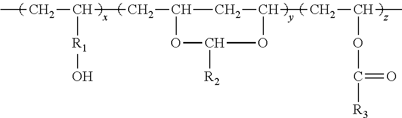
wherein R₁ is a chemical bond or a divalent hydrocarbon linkage having from about 1 to about 20 carbons; R₂ and R₃ are independently an alkyl group, an aromatic group or a substituted aromatic group having from about 1 to about 20 carbon atoms; x, y and z independently represent the proportion of the corresponding repeat units respectively expressed as a weight percent, wherein each repeat unit is randomly distributed along polymer chain, a sum of x, y and z is about 100 weight percent, and x is from about 3 weight percent to about 50 weight percent, y is from about 50 weight percent to about 95 weight percent, and z is from about 0.1 weight percent to about 15 weight percent.

6. The conductive ink paste of claim 5, wherein the polyvinylbutyral terpolymer has a weight average molecular weight of from 10,000 to 600,000 Daltons and a glass transition temperature of from 60° C. to about 100° C.

7. The conductive ink of claim 1, wherein the polyvinylbutyral terpolymer thermoplastic binder comprises an amount of from about 0.1 to about 10 weight percent of the ink.

8. The conductive ink of claim 1, wherein the glycol ether solvent is an ethylene glycol di-C1-C6-alkyl ether, a propylene glycol di-C1-C6-alkyl ether, a diethylene glycol di-C1-C6-alkyl ether, a dipropylene glycol di-C1-C6-alkyl ether, or a combination thereof.

9. The conductive ink of claim 8, wherein the glycol ether solvent is diethylene glycol monobutyl ether.

10. The conductive ink of claim 1, wherein the glycol ether solvent comprises an amount of from about 5 to about 50 weight percent of the ink.

11. The conductive ink of claim 1, wherein the ink has a viscosity of about 40 Pa·s or more at a shear of 1 s⁻¹, and a viscosity of about 25 Pa·s or less when the shear is 50 s⁻¹.

12. The conductive ink of claim 1, wherein the conductive ink has a viscosity of from about 10,000 cps to about 70,000 cps.

13. A conductive ink comprised of a conductive material, a thermoplastic polyvinylbutyral terpolymer binder and a glycol ether solvent, wherein the ink has a sheet resistivity of 12.5 mΩ/sq./mil or less.

14. The conductive ink of claim 13, wherein the conductive material is a conductive particulate having an average size of from about 0.5 to about 10 microns and as aspect ratio of at least about 3 to 1.

15. The conductive ink of claim 14, wherein the conductive material is silver flake having an average size of about 2 to about 10 microns.

16. The conductive ink of claim 14, wherein the polyvinylbutyral terpolymer has the formula 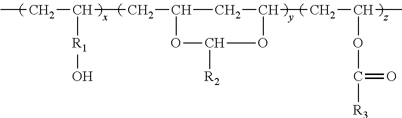
wherein R₁ is a chemical bond or a divalent hydrocarbon linkage having from about 1 to about 20 carbons; R₂ and R₃ are independently an alkyl group, an aromatic group or a substituted aromatic group having from about 1 to about 20 carbon atoms; x, y and z independently represent the proportion of the corresponding repeat units respectively expressed as a weight percent, wherein each repeat unit is randomly distributed along polymer chain, a sum of x, y and z is about 100 weight percent, and x is from about 3 weight percent to about 50 weight percent, y is from about 50 weight percent to about 95 weight percent, and z is from about 0.1 weight percent to about 15 weight percent.

17. The conductive ink of claim 13, wherein the glycol ether solvent is an ethylene glycol di-C1-C6-alkyl ether, a propylene glycol di-C1-C6-alkyl ether, a diethylene glycol di-C1-C6-alkyl ether, a dipropylene glycol di-C1-C6-alkyl ether, or a combination thereof.

18. A conductive ink comprised of
a silver flake having an average size of about 2 to about 10 microns,
a polyvinylbutyral terpolymer binder having the formula 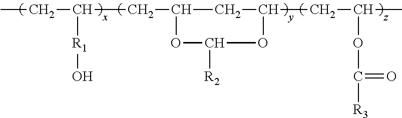
wherein R₁ is a chemical bond or a divalent hydrocarbon linkage having from about 1 to about 20 carbons; R₂ and R₃ are independently an alkyl group, an aromatic group or a substituted aromatic group having from about 1 to about 20 carbon atoms; x, y and z independently represent the proportion of the corresponding repeat units respectively expressed as a weight percent, wherein each repeat unit is randomly distributed along polymer chain, a sum of x, y and z is about 100 weight percent, and x is from about 3 weight percent to about 50 weight percent, y is from about 50 weight percent to about 95 weight percent, and z is from about 0.1 weight percent to about 15 weight percent, and
a glycol ether solvent.

19. The conductive ink of claim 18, wherein the glycol ether solvent is an ethylene glycol di-C1-C6-alkyl ether, a propylene glycol di-C1-C6-alkyl ether, a diethylene glycol di-C1-C6-alkyl ether, a dipropylene glycol di-C1-C6-alkyl ether, or a combination thereof.

20. The conductive ink of claim 18, wherein the ink has a viscosity of about 40 Pa·s or more at a shear of 1 s⁻¹, and a viscosity of about 25 Pa·s or less when the shear is 50 s⁻¹.
